(19) United States
(12) Patent Application Publication
(10) Pub. No.: US 2026/0225936 A1
(43) Pub. Date: Aug. 6, 2026

(54) APPARATUS AND METHOD FOR CONTROLLING GLASS RIBBON CHARACTERISTICS

(71) Applicant: CORNING INCORPORATED, Corning, NY (US)

(72) Inventors: Olus Naili Boratav, Ithaca, NY (US); Chang-Lin Cai, Taichung City (TW); Brendan William Glover, Corning, NY (US); Chih Wei Huang, Taichung (TW); Jiandong Meng, Pittsford, NY (US)

(21) Appl. No.: 19/154,983

(22) PCT Filed: Feb. 6, 2024
(86) PCT No.: PCT/US2024/014551

§ 371 Date: Aug. 8, 2025

Related U.S. Application Data
(60) Provisional application No. 63/447,116, filed on Feb. 21, 2023.

(51) Int. Cl. C03B 17/06

(52) U.S. Cl. CPC C03B 17/064

(57) ABSTRACT

An apparatus and method for manufacturing a glass article include a thickness control device configured to flow a fluid toward the glass ribbon, the thickness control device including at least one pivotable fluid discharge conduit configured to flow the fluid therethrough, wherein rotation of the pivotable fluid discharge conduit changes a flow orientation of the fluid relative to the glass ribbon.

### CROSS-REFERENCE TO RELATED APPLICATIONS

This application claims the benefit of priority under 35 U.S.C. § 119 of U.S. Provisional Application Ser. No. 63/447,116 filed on Feb. 21, 2023, the content of which is relied upon and incorporated herein by reference in its entirety.

### FIELD

The present disclosure relates generally to apparatuses and methods for controlling glass ribbon characteristics and more particularly to apparatuses and methods for controlling glass ribbon thickness.

### BACKGROUND

In the production of glass articles, such as glass sheets for display applications, including televisions and hand-held devices, such as telephones and tablets, the glass articles may be manufactured from glass sheets that are formed from drawing a glass ribbon from a forming body. As the glass ribbon is drawn from the forming body, the thickness of the ribbon may vary in the widthwise direction. Such thickness variation can result in undesirable glass sheet thickness variability or process upsets, particularly with increasing ribbon width and/or decreasing average ribbon thickness. Accordingly, measures to address these issues are desired.

### SUMMARY

Embodiments disclosed herein include an apparatus for manufacturing a glass article. The apparatus includes a forming apparatus configured to house a glass ribbon. The apparatus also includes a thickness control device configured to flow a fluid toward the glass ribbon. The thickness control device includes at least one pivotable fluid discharge conduit configured to flow the fluid therethrough. Rotation of the pivotable fluid discharge conduit changes a flow orientation of the fluid relative to the glass ribbon.

Embodiments disclosed herein also include a method of manufacturing a glass article. The method includes flowing a glass ribbon in a forming apparatus. The method also includes flowing a fluid towards the glass ribbon from at least one pivotable fluid discharge conduit of a thickness control device. Rotation of the pivotable fluid discharge conduit changes a flow orientation of the fluid relative to the glass ribbon.

In addition, embodiments disclosed herein include a thickness control device configured to flow a fluid toward a glass ribbon. The thickness control device includes at least one pivotable fluid discharge conduit configured to flow the fluid therethrough. Rotation of the pivotable fluid discharge conduit changes a flow orientation of the fluid relative to the glass ribbon.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a schematic cutaway view of a glass ribbon;

FIG. 3 is an exploded view of a portion of the glass ribbon of FIG. 2;

FIG. 4 is a schematic top view of a thickness control device in accordance with embodiments disclosed herein;

FIG. 5 is a schematic side view of the thickness control device of FIG. 4;

FIGS. 6A and 6B are schematic end views of pivotable fluid discharge conduits in accordance with embodiments disclosed herein;

FIG. 7 is a schematic top view of thickness control devices positioned relative to a glass ribbon in accordance with embodiments disclosed herein;

FIG. 8 is a schematic end view of thickness control devices positioned relative to a glass ribbon in accordance with embodiments disclosed herein;

FIG. 9 is an exploded view of a portion of the glass ribbon of FIG. 7; and

FIG. 10 is a exploded view of the portion of the glass ribbon of FIG. 9.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “particles” refers to any type of particles that can be present on a surface, such as glass particles and dust particles.

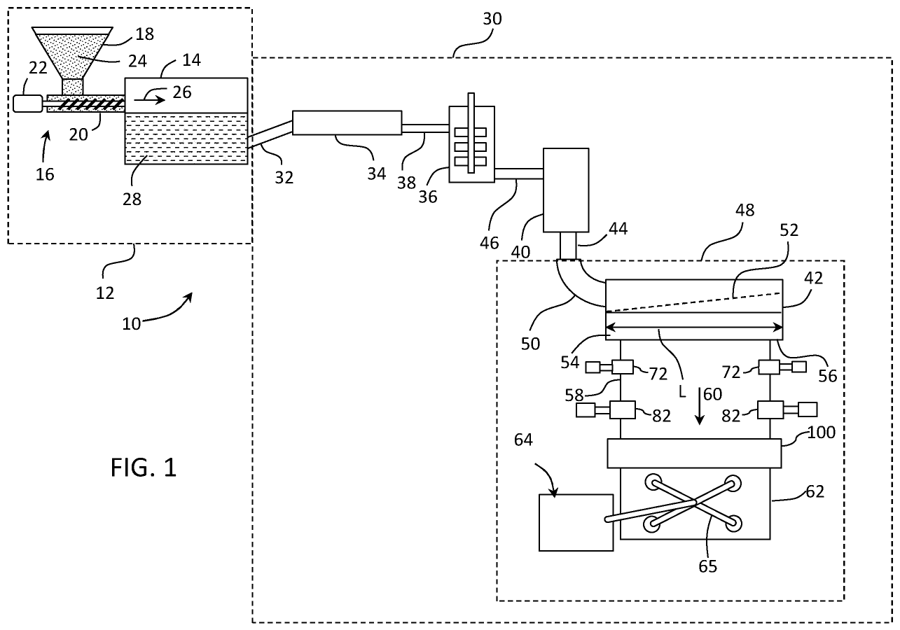

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw glass manufacturing apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example in examples, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body 42. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

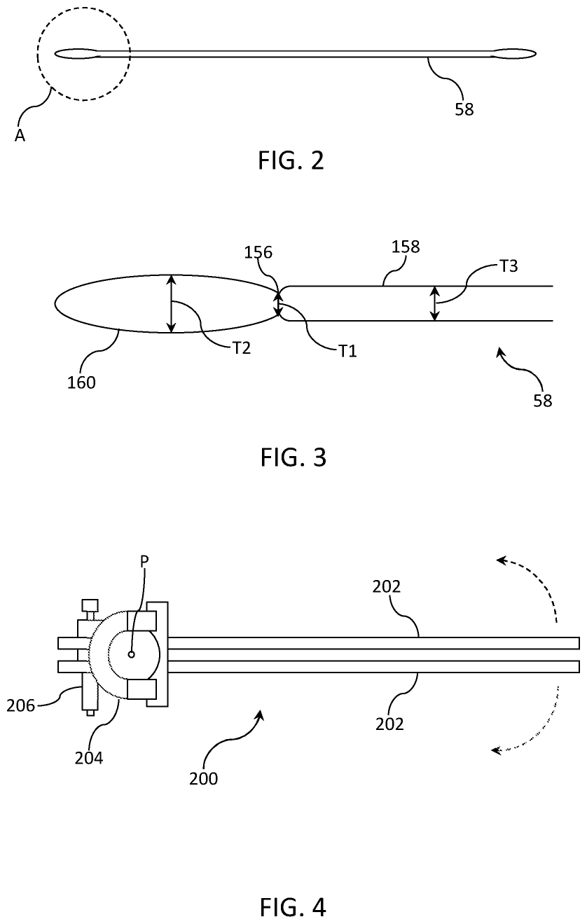

FIG. 2 shows a schematic cutaway view of a glass ribbon 58, such as a glass ribbon 58 formed in forming apparatus 48. FIG. 3 shows an exploded view of a portion of the glass ribbon 58 of FIG. 2, specifically the portion of glass ribbon 58 shown in area ‘A’ of FIG. 2. Glass ribbon 58 includes central region 158 (also referred to as “quality region”) and end region 160 (also referred to as “bead region”). In addition, glass ribbon 58 includes intermediate region 156 between central region 158 and end region 160. As can be seen from FIG. 3, glass ribbon 58 has a minimum thickness T1 in intermediate region 156 and a maximum thickness T2 in end region 160, wherein T2 is greater than T1. In addition, glass ribbon 58 has an intermediate thickness T3 in central region 158, wherein T3 is greater than T1 and less than T2.

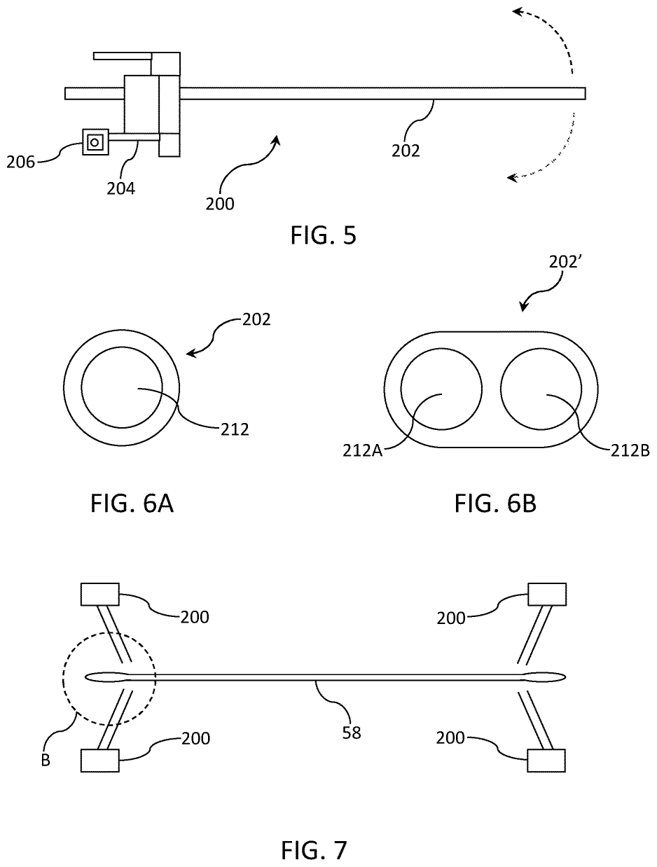

FIGS. 4 and 5 show, respectively, schematic top and side views of a thickness control device 200 in accordance with embodiments disclosed herein. Thickness control device 200 includes two substantially parallel pivotable fluid discharge conduits 202 each extending through a turret assembly 204. Pivotable fluid discharge conduits 202 are each configured to flow a fluid therethrough and turret assembly 204 is configured to effectuate at least one of vertical or horizontal rotation of pivotable fluid discharge conduits 202, wherein vertical rotation of pivotable fluid discharge conduits 202 is shown schematically by dashed arrows in FIG. 5 and horizontal rotation of pivotable fluid discharge conduits 202 is shown schematically by dashed arrows in FIG. 4.

Turret assembly 204 can be assembled and operated in accordance with methods known to persons having ordinary skill in the art and can effectuate rotation of pivotable fluid discharge conduits 202 via drive mechanism 206, which, in certain exemplary embodiments, may comprise a precision adjustable micrometer drive in mechanical communication with turret assembly 204. Turret assembly 204 may also be manually adjusted to effectuate rotation of pivotable fluid discharge conduits 202.

And while FIG. 4 shows thickness control device 200 with two substantially parallel fluid discharge conduits 202, embodiments disclosed herein include thickness control devices with greater or fewer numbers of fluid discharge conduits, such as one fluid discharge conduit or at least three substantially parallel fluid discharge conduits, such as three, four, or five substantially parallel fluid discharge conduits.

FIGS. 6A and 6B show schematic end views of pivotable fluid discharge conduits 202 and 202′ in accordance with embodiments disclosed herein. Specifically, FIG. 6A shows a schematic end view of a fluid discharge conduit 202 having a single internal bore 212 extending therethrough whereas FIG. 6B shows a schematic end view of a fluid discharge conduit 202′ having substantially parallel dual bores 212A and 212B extending therethrough. And while FIGS. 6A and 6B show fluid discharge conduits 202 and 202′ having, respectively, single and dual bores extending therethrough, embodiments disclosed herein include fluid discharge conduits having at least three internal bores extending therethrough, such as fluid discharge conduits having three, four, or five internal bores extending therethrough.

In certain exemplary embodiments, fluid discharge conduits 202 or 202′ comprise a refractory material able to withstand temperatures of at least about 1200 degrees C. For example, fluid discharge conduits 202 or 202′ may comprise a refractory ceramic material, such as alumina, mullite, or zirconia.

FIG. 7 shows a schematic top view of thickness control devices 200 positioned relative to a glass ribbon 58 in accordance with embodiments disclosed herein. Specifically, FIG. 7 shows four thickness control devices 200, two of which are positioned on opposing sides of a first end of glass ribbon 58 (near end or “bead” regions 160) and two of which are positioned on opposing sides of a second end of glass ribbon 58 (near end or “bead” regions 160). Thickness control devices 200 are each positioned to direct a flow of fluid toward glass ribbon 58 via pivotable fluid discharge conduits 202, wherein rotation of pivotable fluid discharge conduits 202 changes a flow orientation of the fluid relative to glass ribbon 58.

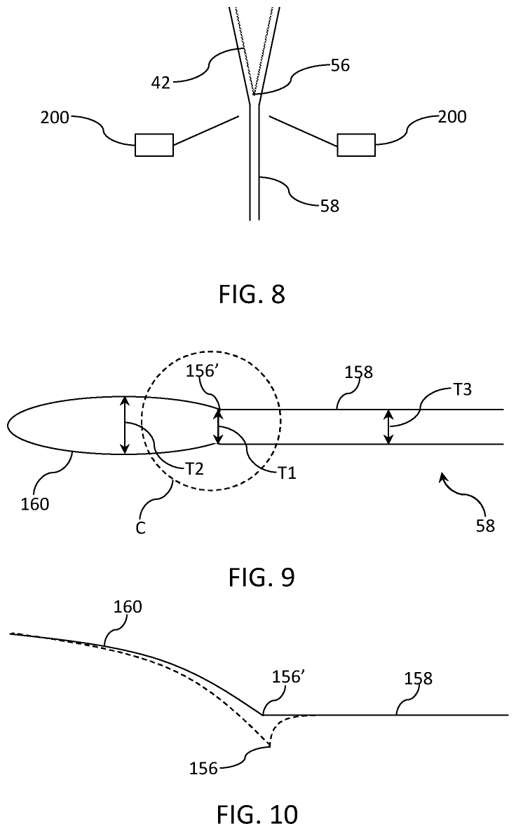

FIG. 8 shows a schematic end view of thickness control devices 200 positioned relative to a glass ribbon 58 in accordance with embodiments disclosed herein. Specifically, FIG. 8 shows two thickness control devices 200 each positioned on opposing sides of a glass ribbon 58 near bottom edge 56 of forming body 42. Thickness control devices 200 are each positioned to direct a flow of fluid toward glass ribbon 58 via pivotable fluid discharge conduits 202, wherein rotation of pivotable fluid discharge conduits 202 changes a flow orientation of the fluid relative to glass ribbon 58.

In certain exemplary embodiments, fluid flowed toward glass ribbon 58 via pivotable fluid discharge conduits 202 comprises a gas, such as at least one gas selected from air, nitrogen, helium, or argon.

In certain exemplary embodiments, the flowrate of fluid flowed toward glass ribbon 58 via pivotable fluid discharge conduits 202 can be controlled, adjusted, or varied in order to effectuate a desired amount of localized cooling within a predetermined area of glass ribbon 58. Such fluid flowrate control or adjustment may, for example, be carried out by a control mechanism, such as a feedback or feedforward control mechanism as known to persons having ordinary skill in the art.

In certain exemplary embodiments, fluid is flowed from the thickness control device 200 toward a portion of the glass ribbon 58 having a viscosity ranging from about 80 kP to about 200 kP, such as from about 120 kP to about 160 kP.

In certain exemplary embodiments, a temperature of the fluid flowed toward glass ribbon 58 via pivotable fluid discharge conduits 202 ranges from about 20 degrees C. to about 40 degrees C.

FIG. 9 shows an exploded view of a portion of the glass ribbon 58 of FIG. 7 and FIG. 10 shows a exploded view of the portion of the glass ribbon 58 of FIG. 9 (shown within area ‘C’ of FIG. 9). Specifically, FIGS. 9 and 10 show exploded views of a glass ribbon 58 subjected to fluid flow from thickness control device 200. As can be seen in FIGS. 9 and 10, glass ribbon 58 has a maximum thickness T2 in end region 160 and near equivalent minimum thickness T1 and T3 in intermediate region 156 and central region 158, respectively, wherein T2 is greater than T1 or T3. Moreover, the thickness difference between T1 and T2 of the glass ribbon 58 of FIGS. 9 and 10 is less than the thickness difference between T1 and T2 of the glass ribbon 58 of FIG. 3. Specifically, dashed line of FIG. 10 represents glass ribbon 58 of FIG. 3 and as can be seen from FIG. 10, thickness T1 of intermediate region 156 of glass ribbon 58 of FIG. 3 is less than thickness T1 of intermediate region 156 of glass ribbon 58 of FIGS. 9 and 10 such that the thickness variation (i.e., the difference between maximum thickness T2 and minimum thickness T1) of the glass ribbon 58 of FIGS. 9 and 10 is less than the thickness variation of the glass ribbon 58 of FIG. 3.

Accordingly, embodiments disclosed herein include those in which a thickness variation of glass ribbon 58 is reduced by at least about 20%, such as at least about 30%, and further such as at least about 40%, and yet further such as at least about 50%, such as from about 20% to about 80%, and further such as from about 30% to about 70% relative to a condition wherein a fluid is not flowed toward the glass ribbon 58 from at least one pivotable fluid discharge conduit 202 of a thickness control device 200.

Such thickness variation reduction can, for example, be achieved by targeting a portion of glass ribbon 58 known to have reduced thickness during the course of a production campaign in order to increase the relative thickness of that portion. Such targeting can include rotating or orienting pivotable fluid discharge conduits 202 toward a targeted portion of glass ribbon 58 in order control or change a flow orientation of fluid relative to glass ribbon 58. Such targeting can also include adjusting the flowrate, temperature, and/or type of fluid flowed toward glass ribbon 58 via pivotable fluid discharge conduits 202 of thickness control device 200. Such parameters can, for example, be adjusted in real time using, for example, a control mechanism, such as a feedback or feedforward control mechanism as known to persons having ordinary skill in the art.

In certain exemplary embodiments, pivotable fluid discharge conduits 202 are oriented to flow fluid toward glass ribbon 58 within a predetermined distance of intermediate region 156 along a widthwise direction of glass ribbon 58, such as within the area ‘C’ of FIG. 9. For example, embodiments disclosed herein include those in which pivotable fluid discharge conduits 202 are oriented to flow fluid toward glass ribbon 58 within 0.1 meter, such as within 0.05 meters of intermediate region 156 along the widthwise direction of glass ribbon 58.

Embodiments disclosed herein include those in which glass ribbon 58 comprises a glass composition, such as an alkali free glass composition, comprising 58-65 weight percent (wt %) SiO₂, 14-20 wt % Al₂O₃, 8-12 wt % B₂O₃, 1-3 wt % MgO, 5-10 wt % CaO, and 0.5-2 wt % SrO. Glass ribbon 58 may also comprise a glass composition, such as an alkali free glass composition, comprising 58-65 wt % SiO₂, 16-22 wt % Al₂O₃, 1-5 wt % B₂O₃, 1-4 wt % MgO, 2-6 wt % CaO, 1-4 wt % SrO, and 5-10 wt % BaO. In addition, glass ribbon 58 may comprise a glass composition, such as an alkali free glass composition, comprising 57-61 wt % SiO₂, 17-21 wt % Al₂O₃, 5-8 wt % B₂O₃, 1-5 wt % MgO, 3-9 wt % CaO, 0-6 wt % SrO, and 0-7 wt % BaO. Glass ribbon 58 may also comprise a glass composition, such as an alkali containing glass composition, comprising 55-72 wt % SiO₂, 12-24 wt % Al₂O₃, 10-18 wt % Na₂O, 0-10 wt % B₂O₃, 0-5 wt % K₂O, 0-5 wt % MgO, and 0-5 wt % CaO, which, in certain embodiments, may also comprise 1-5 wt % K₂O and 1-5 wt % MgO.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

1. An apparatus for manufacturing a glass article comprising:
a forming apparatus configured to house a glass ribbon; and
a thickness control device configured to flow a fluid toward the glass ribbon, the thickness control device comprising at least one pivotable fluid discharge conduit configured to flow the fluid therethrough, wherein rotation of the at least one pivotable fluid discharge conduit changes a flow orientation of the fluid relative to the glass ribbon.

2. The apparatus of claim 1, wherein the forming apparatus houses a forming body configured to flow the glass ribbon therefrom in a flow direction and the thickness control device is configured to flow the fluid downstream of the forming body.

3. The apparatus of claim 1, wherein the thickness control device comprises at least two substantially parallel pivotable fluid discharge conduits.

4. The apparatus of claim 1, wherein the thickness control device comprises a turret assembly configured to effectuate at least one of vertical rotation or horizontal rotation of the at least one pivotable fluid discharge conduit.

5. The apparatus of claim 1, wherein the fluid comprises a gas.

6. A method of manufacturing a glass article comprising:
flowing a glass ribbon in a forming apparatus; and
flowing a fluid towards the glass ribbon from at least one pivotable fluid discharge conduit of a thickness control device, wherein rotation of the at least one pivotable fluid discharge conduit changes a flow orientation of the fluid relative to the glass ribbon.

7. The method of claim 6, wherein the glass ribbon is flowed in a flow direction from a forming body and the fluid is flowed from the thickness control device downstream of the forming body.

8. The method of claim 6, wherein the fluid comprises a gas.

9. The method of claim 6, wherein the fluid is flowed from the thickness control device toward a portion of the glass ribbon having a viscosity ranging from about 80 kP to about 200 kP.

10. The method of claim 6, wherein a thickness variation of the glass ribbon is reduced by at least about 20% relative to a condition wherein a fluid is not flowed toward the glass ribbon from at least one pivotable fluid discharge conduit of a thickness control device.

11. A thickness control device configured to flow a fluid toward a glass ribbon comprising at least one pivotable fluid discharge conduit configured to flow the fluid therethrough, wherein rotation of the at least one pivotable fluid discharge conduit changes a flow orientation of the fluid relative to the glass ribbon.

12. The thickness control device of claim 11, wherein the thickness control device comprises at least two substantially parallel pivotable fluid discharge conduits.

13. The thickness control device of claim 11, wherein the thickness control device comprises a turret assembly configured to effectuate at least one of vertical rotation or horizontal rotation of the at least one pivotable fluid discharge conduit.

14. A glass article made by the method of claim 6.

15. An electronic device comprising the glass article of claim 14.
